(19) United States
(12) Patent Application Publication
(10) Pub. No.: US 2004/0194285 A1
(43) Pub. Date: Oct. 7, 2004

(54) Electro-acoustic transducer and method of manufacturing the same

(76) Inventors: Kazuro Okuzawa, Mie (JP); Akira Fukushima, Mie (JP)

Correspondence Address: RATNERPRESTIA, P O BOX 980, VALLEY FORGE, PA, 19482-0980, US

(21) Appl. No.: 10/828,701

(22) Filed: Apr. 21, 2004

Related U.S. Application Data
(63) Continuation of application No. 09/913,934, filed on Dec. 18, 2001.
Application No. 09/913,934 is a 371 of international application No. PCT/JP00/07813, filed on Nov. 7, 2000.

(30) Foreign Application Priority Data
Dec. 20, 1999 (JP) 11-360255

(51) Int. Cl. H04R 1/02; H04R 11/02

(52) U.S. Cl. 29/594; 381/396

(57) ABSTRACT

An electro-acoustic transducer has a layer of a heat-curing and UV-curing adhesive formed on a frame integrally molded at the bottom of a case. A magnet is placed on the frame via the adhesive. The case is irradiated with a UV light from above, at least before the adhesive is heat-cured, so that the adhesive is cured in the portion exposed to the UV light. This prevents the adhesive from evaporating, scattering and prevents the adhesive components depositing on a diaphragm, that could be caused by a later high temperature process for heat-curing the adhesive. Furthermore, time for the heat-curing can be made shorter by the high temperature curing. The shorter curing time improves productivity of the production, and allows the transducers to be manufactured on an automatic assembly line.

This application is a continuation of U.S. patent application Ser. No. 09/913,934, filed Dec. 18, 2001, which is a U.S. National Phase Application of PCT International Application PCT/JP00/07813.

### FIELD OF THE INVENTION

The present invention relates to an electro-acoustic transducer for use in cellular phones and the like devices to make call sounds, etc. A method of manufacturing the transducers is also contained in the invention.

### BACKGROUND OF THE INVENTION

Conventional technologies are described with reference to drawings. FIG. 3 is a cross sectional view of a conventional electromagnetic type electro-acoustic transducer.

As shown in FIG. 3, a conventional electro-acoustic transducer comprises:

a) a case 1 formed by resin molding;

b) a frame 2 of cold rolled steel sheet formed integrally with the case 1;

c) a center pole 4, which is press fit to the frame 2;

d) a coil 3 wound around the center pole 4;

e) a magnet 5 bonded on the frame 2 using an adhesive 6;

f) a diaphragm 7 of a magnetic material provided on the magnet 5; and

g) a resonance box 8 having a sound hole 9, bonded on the case 1.

The adhesive 6 is an epoxy resin.

The above described electromagnetic type electro-acoustic transducer generates sounds with the diaphragm 7, which vibrates when electric current is applied to a coil 3 from an external power supply source (not shown) via a terminal section (not shown).

An epoxy resin is used for the adhesive 6 as recited above. And epoxy resin adhesive 6 needs a long curing time to provide a sufficient adhesive strength. Therefore, during a production of the electro-acoustic transducers, the semi-assembled units have to be stored in an oven or the like heating apparatus for a duration of approximately one hour or more in order to heat-cure the epoxy resin. The heat-curing process is a necking factor in automating a production line for the conventional electromagnetic type electro-acoustic transducers.

The manufacturing productivity could be improved by raising a heating temperature. However, the adhesive 6 may evaporate and scatter in the high temperature. The evaporation and scattering of adhesive 6 leads to a deteriorated adhesive strength. Besides, the evaporated adhesive 6 scattered and deposited on the diaphragm 7 decreases a sound pressure. In view of these drawbacks, the high temperature curing has not been employed in most of the manufacturing process.

### DISCLOSURE OF THE INVENTION

The present invention relates to an electro-acoustic transducer for use in cellular phones and the like devices to make call sounds, etc. The present invention also provides a method of manufacturing the electro-acoustic transducers. The present invention aims to provide an electro-acoustic transducer with a stable quality and high productivity.

An electro-acoustic transducer of the present invention comprises:

a) a case molded integrally with a frame at the bottom;

b) a heat-curing and UV (ultra violet ray)-curing adhesive layer formed on the frame;

c) a magnet bonded on the frame via the heat-curing and UV-curing adhesive layer;

d) a diaphragm provided above the magnet; and

e) a resonance box 8 having a sound hole 9, bonded on the case 1.

The heat-curing and UV-curing adhesive used in the above-configured electro-acoustic transducer is processed with,

a process to be cured by a UV light irradiation, and

a process to be cured by heat, after it is cured by the UV irradiation.

Taking advantage of the property of the present adhesive, the evaporating and scattering of the adhesive during the heat-curing process is prevented. Therefore, a magnet can be bonded on a frame within a short period of time, which leads to an improved productivity in the production of electro-acoustic transducers.

Another electro-acoustic transducer of the present invention comprises:

a) a case molded integrally with a frame at the bottom;

b) a magnet attached on the frame via a heat-curing adhesive layer;

c) a UV-curing resin layer formed on the case containing the magnet; and

d) a diaphragm provided above the magnet.

In the above-described structure, the UV-curing resin layer is cured by a UV irradiation, before the heat-curing adhesive is cured. This prevents the upward evaporation and scattering of the heat-curing adhesive that could occur during a later heat-curing process. As a result, a magnet can be bonded on a frame within a short time, and the manufacturing productivity is improved.

### BRIEF DESCRIPTION OF THE DRAWINGS

FIG. 1 is a cross sectional side view of an electro-acoustic transducer in accordance with a first exemplary embodiment of the present invention.

FIG. 2 is a cross sectional side view of a modification example of the electro-acoustic transducer of FIG. 1.

FIG. 3 is a cross sectional side view of a conventional electro-acoustic transducer.

### BEST MODE FOR CARRYING OUT THE INVENTION

Examples of preferred embodiments of the present invention are described in the following with reference to the drawings. In the drawings, those components of the transducers of the present invention having the same functions as those in the conventional technology are represented by the same numerals or symbols used in describing the conventional technology, and descriptions on these components are omitted.

First Embodiment

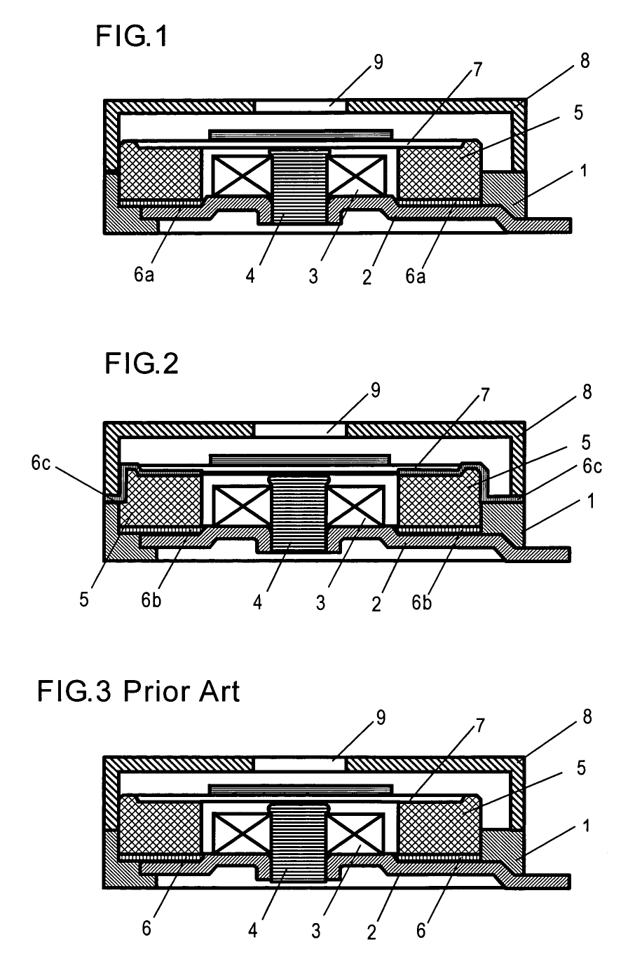

FIG. 1 is a cross sectional side view of an electromagnetic type electro-acoustic transducer in accordance with a first exemplary embodiment of the present invention. Referring to FIG. 1, an adhesive 6a coated in the form of a layer is a heat-curing and UV-curing adhesive that cures by heat within a shorter period of time as compared with an epoxy resin.

In an electromagnetic type electro-acoustic transducer of the first embodiment, a frame 2 is integrally molded with a case 1 at the bottom. A magnet 5 is provided on the frame 2 via the heat-curing and UV-curing adhesive 6a. The heat-curing and UV-curing adhesive 6a is applied on at least one of the joining faces of the frame 2 and the magnet 5. A diaphragm 7 is provided above the magnet 5, and a resonance case 8 is bonded on the case 1.

The above electro-acoustic transducer is assembled in following processes:

1) The magnet 5 is placed on the frame 2. At this stage, the heat-curing and UV-curing adhesive 6a is disposed in between the magnet 5 and the frame 2.

2) The magnet 5 and the frame 2 are UV light irradiated from above the case 1 and the magnet 5.

3) After the UV radiation, heat-curing and UV-curing adhesive 6a is further heated to be cured.

4) After curing the adhesive 6a, the diaphragm 7 is disposed above the magnet 5, and the resonance case 8 is bonded on the case 1.

Thus, the electro-acoustic transducer of the first exemplary embodiment is assembled.

Next, the reason why a heat-curing and UV-curing adhesive 6a is used for the adhesive, and why a UV light irradiation is applied from above the case 1 before it is cured by heat is described in detail. Physical property of the adhesive 6a is viscous. When the magnet 5 is placed on the frame 2, they attract each other, pushing part of the adhesive out, the amount depending on the viscosity of the adhesive, through small gaps between the case 1 and the magnet 5. In a case where the magnet 5 is a molded plastic magnet, there are cracks and voids within it which occur at the time of molding, and the adhesive sometimes oozes out also through the cracks and voids to appear on the upper surface of the magnet 5.

When the case 1 is exposed to a UV radiation from above, the crept out adhesive 6a is cured in the first step. Then, when it is heated at a high temperature, the adhesive 6a staying between the magnet 5 and the frame 2 is heat-cured bringing the two components into a firmly bonded state.

As described above, the crept out portion of the heat-curing and UV-curing adhesive 6a exposed out of the magnet 5 and the case 1 is cured in the first place by the UV light irradiation. The cured portion works to suppress evaporation and scattering of the adhesive 6a during the heat-curing process. Thus the magnet 5 can be firmly bonded on the frame 2 within a short time, without inviting a deterioration in the adhesive strength.

Now in the following, results of experiments are described, which were conducted to confirm the above statements.

Experiment 1 (Adhesive Strength Test)

The experiment compares the adhesive strength of the electro-acoustic transducer samples using the adhesive in the first embodiment and that of the electro-acoustic transducer samples using a conventional adhesive.

1. Manufacturing of Samples in Accordance with the First Embodiment.

An aerophobic U V-curing acrylic adhesive (FMD-210 by Loctite Japan Co. Ltd.) was used for the adhesive.

A 2. 5 mg of above adhesive 6a was applied on a soldered reed insert-molded frame 2.

A magnet 5 was placed on the frame 2, on which the adhesive 6a had been applied, and then exposed to UV light irradiation of a quantity of 3000-4000 mj.

2. Manufacturing of the Conventional Samples.

A one-liquid type epoxy adhesive (short curing time) was used for the adhesive.

A 2. 5 mg of the above adhesive 6 was applied on a soldered reed insert-molded frame 2.

A magnet 5 was placed on the frame 2, which had been applied with the adhesive 6.

As described above, the samples in the first embodiment and the conventional samples were manufactured using adhesives of different type. After the magnet 5 is placed on the frame 2, UV light irradiation was applied on the samples in the first embodiment, while no UV light irradiation was applied on the conventional samples.

Prior to measurement with respect to the adhesive strength, respective frames of the samples in the first embodiment and those of conventional samples were placed on a 150° C. heating plate for 5 min. The heating conditions remain the same for both of the samples.

After the 150° C. heating was finished, adhesive strength between the magnet 5 and the frame 2 was measured.

The adhesive strength was measured by pushing the magnet 5 from behind the bottom through a small hole provided in the frame 2, and a force when the magnet 5 separates from the frame 2 was recorded. The method of measuring the adhesive strength remains the same for both of the samples, the first embodiment and the conventional.

Table 1 shows results of the measurement, with respect to the adhesive strength.

TABLE 1

| | | Conventional |
|---|---|---|
| | | electro-acoustic |
| | Electro-acoustic transducer | transducer |
| | samples in embodiment 1 | samples |
| Adhesive strength | 100 N-130 N | 90 N-110 N |

From the above results, it has been confirmed that the adhesive strength with the electro-acoustic transducer samples in accordance with the first embodiment of the present invention is not inferior to that of the sample pieces of conventional electro-acoustic transducers in which a conventional epoxy resin was used.

The adhesive strength with the samples in the first embodiment is on a slight higher level, as compared with that of the samples using a conventional epoxy resin. The higher adhesive strength seems to have been brought about by the adhesive 6a that has been entirely staying, without being scattered, in a gap between the magnet 5 and the case 1 to be cured.

Experiment 2 (Simulation for Mounting on a Circuit Board)

The samples of electro-acoustic transducer manufactured in accordance with the present invention used in the above experiment 1 have been completed as the finished transducer samples by adding a diaphragm 7 and a resonance case 8 thereon. The resonance case 8 is attached to the case 1 through an ultrasonic welding. Likewise, the conventional sample pieces were added with a diaphragm 7 and a resonance case 8 to be completed as the finished transducer samples. Both of the sample transducers were measured with respect to the sound pressure characteristic, and then heated in an atmosphere of 260° C. for 5 min. The heating conditions, 260° C., 5 min., are based on a simulated reflow soldering of electro-acoustic transducers mounted on a circuit board of an appliance. After the above heating for 5 min., both of the sample transducers were again measured with respect to the sound pressure, to be compared with those before the 260° C. heating. Table 2 shows the results of sound pressure measurement. After the measurement was finished, the resonance case 8 and the diaphragm 7 were removed, and the diaphragm 7 was inspected as to whether there was any foreign material sticking on the diaphragm 7. And the adhesive strength between the magnet 5 and the frame 2 was also measured with both of the samples. The results of measurement in adhesive strength are shown in Table 2.

TABLE 2

| | Electro-acoustic | |
|---|---|---|
| | transducer samples | Conventional electro-acoustic |
| | in embodiment 1 | transducer samples |
| Adhesive strength | 60 N-80 N | 5 N-10 N |
| Change in sound | No change observed | Changed due to the adhesive |
| pressure | | sputtered on the diaphragm |
| characteristic | | (decreased by 10 db-15 db) |

As Table 2 shows, it has been confirmed, after undergoing the 260° C., 5 min. heating, that the samples in the first embodiment are superior to the conventional samples with respect to all of the measurement items, such as change in the sound pressure, the adhesive strength and sticking of foreign materials on the diaphragm 7. The foreign material sticking on the diaphragm of the conventional samples has been confirmed to be components of the adhesive.

Based on the above-described results, it is assumed that the conventional adhesive 6 cured at a relatively low temperature in the conventional samples partly remains uncured, because of the low temperature applied thereto. When the uncured portion of adhesive 6 undergoes a high temperature, the portion evaporates to become a gas. The evaporated gas escapes through the gaps between the magnet 5 and the case 1 as well as cracks and voids existing within the magnet 5, and it is deposited on the diaphragm 7 from the above.

An assumption with the adhesive 6a used in the sample electro-acoustic transducers in the first embodiment is that:

When a magnet 5 is placed on a frame 2, part of the adhesive 6a is pushed out through the gaps and the cracks and voids to be exposed on the surface. The exposed adhesive 6a is cured in the first place by a UV light irradiation, and the gaps and the cracks and voids are sealed. Thus the channels of upward escaping are blocked, and deposition of the adhesive on the diaphragm 7 has been avoided.

As described above, the exposed portion of adhesive 6a is cured in the first place by the UV light irradiation, sealing the gaps and the cracks and voids. This prevents the adhesive components from sticking on the surface of diaphragm 7. So, the adhesive can be cured at a high temperature, which was not allowed for the conventional electro-acoustic transducers. The high temperature curing shortens the curing time to an improved productivity in the production. This makes it possible to manufacture the electro-acoustic transducers on an automatic (mechanized) assembly line.

The electro-acoustic transducer in accordance with the first embodiment of the present invention, where a heat-curing and UV-curing adhesive 6a is applied in between the magnet 5 and the frame 2, provides a new device structure that is suitable to the production at a high manufacturing efficiency. At the same time, a new method of manufacturing the transducers is provided by the present invention.

The Second Embodiment

FIG. 2 is a cross sectional side view of an electromagnetic type electro-acoustic transducer in accordance with a second exemplary embodiment of the present invention. The second embodiment is a modification of the electromagnetic type electro-acoustic transducer in the first embodiment. The components identical to those in the conventional technology and to the first embodiment are represented by using the same reference numerals, and description on which are omitted.

Referring to FIG. 2, a magnet 5 is placed on a frame 2 via a heat-curing adhesive 6b. The heat-curing adhesive 6b is applied on at least one of the joining faces of the frame 2 and the magnet 5. After the magnet 5 is placed on frame 2, a UV-curing adhesive 6c is provided from above a case 1 including frame 2 and magnet 5. A diaphragm 7 is placed on the UV-curing adhesive 6c provided on magnet 5, and a resonance case 8 is bonded on the case 1.

The above electro-acoustic transducer is assembled as follows:

1) The magnet 5 is placed on the frame 2. At this stage, there is heat-curing adhesive 6b disposed in between the magnet 5 and the frame 2.

2) The UV-curing adhesive 6c is provided from above magnet 5 and frame 2.

3) The UV-curing adhesive 6c thus provided is exposed to a UV light irradiation and UV-curing adhesive 6c is cured.

4) After the UV light irradiation, further heating is proceeded to make the heat-curing adhesive 6b cured.

5) After the adhesive 6b is cured, the diaphragm 7 is disposed above the magnet 5, and the resonance case 8 is bonded on the case 1.

The electromagnetic type electro-acoustic transducers in the second embodiment have the above-described configuration, and are assembled according to the above processes.

The curing time can be made shorter with the above structure. The electro-acoustic transducers in the second embodiment can be manufactured on an automatic (mechanized) assembly line, like those in the first embodiment.

In the above description, a heat-curing adhesive 6b is used for bonding magnet 5 onto frame 2. However, a self-curing adhesive, for example an acrylic adhesive using a primer including a polymerization initiator, may be used instead for the purpose.

The electro-acoustic transducers in the second embodiment have the same advantage as that in the first embodiment, in that the sound generating characteristic in the present invention is hardly ill-affected by the heat of a reflow solder bath, which is used when mounting a transducer on a circuit board of an appliance.

### INDUSTRIAL APPLICABILITY

In the transducers of the present invention having the above-described structures, the surface, the gaps and voids of the case and magnet among them are filled with UV-curing adhesive, and it is cured. Therefore, a possible evaporation and gas generation of the adhesive existing between the frame and the magnet to be caused by a heat applied in a later stage can be suppressed; hence, the influence therefrom on the diaphragm is eliminated. Furthermore, the curing time can be made shorter for an improved productivity.

1. A method of manufacturing an electro-acoustic transducer comprising the steps of:
providing a frame;
forming an adhesive layer on the frame;
forming a frame-magnet laminate by disposing a magnet on the frame with the adhesive layer in between;
irradiating UV light to the laminate from above the magnet to cure a portion of the adhesive layer;
heating the frame-magnet laminate to cure a remaining portion of the adhesive layer; and
disposing a diaphragm above said magnet.

2. The method of claim 1, wherein a case is integrally molded with the frame, further comprising a step of bonding a resonance case to the case integrally molded with the frame.

3. The method of claim 2, wherein the resonance case is provided with a sound hole.

4. The method of claim 1, wherein the adhesive layer is a heat-curing and UV-curing adhesive layer.

5. The method of claim 4, wherein the portion to be cured by the UV light irradiation is a crept out portion of the heat-curing and UV-curing adhesive layer.

6. The method of claim 1, further comprising a step of forming a UV-curing adhesive layer on the magnet and on the case of the frame-magnet laminate before the irradiating step.

7. The method of claim 5, wherein the adhesive layer formed on the frame is one of a heat-curing adhesive layer and a self-curing adhesive layer.
